(19) United States
(12) Patent Application Publication
(10) Pub. No.: US 2003/0057676 A1
(43) Pub. Date: Mar. 27, 2003

(54) Vehicle-mountable holder for stowing a receiver hitch

(76) Inventors: Stephen S. Griggs, Orem, UT (US); Clint J. Baum, Pleasant Grove, UT (US)

Correspondence Address: Angus C. Fox, III, 4093 North Imperial Way, Provo, UT, 84604-5386, US

(21) Appl. No.: 09/967,570

(22) Filed: Sep. 27, 2001

(51) Int. Cl. B60D 1/01

(52) U.S. Cl. 280/504; 280/507

(57) ABSTRACT

A hitch holder is designed for mounting on either the frame or bed of a vehicle, such as a pick-up truck. A first embodiment holder is mountable on a horizontal surface, and includes a square-tube receiver portion that is welded to a mounting plate that is drilled for bolting to the floor of a pick-up bed. A mounting bracket accessory may be employed to indirectly secure the first embodiment hitch to the horizontal surface. A second embodiment holder is designed for mounting on a vertical surface, such as the side panel of a frame rail. The second embodiment holder includes a flat mounting plate drilled to accept screw-type fasteners, by means of which the plate may be anchored to the vertical surface. A third embodiment hitch holder is designed for flush mounting on a horizontal vehicle body panel. All three embodiments may be fitted with a hitch holder tree having multiple receiver portions, each of which may hold a single hitch.

### FIELD OF THE INVENTION

The present invention relates to towing devices for motor vehicles and, more particularly, to removable receiver type hitches and devices for stowing such hitches.

### BACKGROUND OF THE INVENTION

Ball hitches mounted on both automobiles and trucks are widely used to tow many types of trailers. Because different classes of trailers use hitch balls of different diameters, it is often necessary to change a mounted hitch ball for another of different size. Receiver hitches are those in which a receiver is rigidly affixed to a vehicle. The receiver typically has a horizontally aligned tube of square cross section into which a hitch shank of square cross section may be inserted and releasably secured with a hitch pin. A receiver hitch assembly includes a hitch shank on which is mounted a hitch ball. A receiver hitch system has several advantages over a permanently installed hitch. Firstly, the hitch shank/ball assembly may be removed when not in use, thereby eliminating a major source of bruised shins and a stylistic eyesore. Secondly, because hitch balls of various sizes may each be attached to a dedicated hitch shank, a mounted hitch shank/ball assembly may be easily removed and replaced with another hitch shank/ball assembly.

Because hitch balls of various sizes are often needed, it is generally advantageous to carry a hitch assembly for each size hitch ball that might be required. In such a case, one hitch assembly typically remains mounted in the towing position on the vehicle. The other hitch assembly is stowed loose within the vehicle. In a pickup truck, the extra hitch assembly is often placed unsecured in the bed. When the extra hitch assembly experiences acceleration, whether from turns, braking or straight-line acceleration, inertia causes it to become a projectile as it slides within the bed. The movement and sudden deceleration as it strikes the sides of the bed or other cargo can cause significant damage to the truck body and/or cargo. Because the extra hitch assembly is generally unsecured, it is may also be easily stolen.

What is needed is a device for securely stowing one or more hitch assemblies on a vehicle in order to protect them from theft and prevent them from damaging the vehicle and any cargo. Ideally, the device should be relatively inexpensive, simple to use, and simple to install with minimal alterations to the vehicle required. In addition, the device should be unobtrusive and should interfere no more than minimally with the cargo carrying capability of the vehicle.

### SUMMARY OF THE INVENTION

The present invention answers the heretofore expressed need for a vehicle-mountable holder for stowing a receiver hitch. Several embodiments of such a holder are disclosed herein.

A first embodiment of the hitch holder is designed for mounting on a horizontal surface, such as the floor of a pick-up bed. This embodiment includes a flat mounting plate drilled to accept screw-type fasteners, by means of which the plate may be anchored to the floor. It also includes a square-tube receiver portion that is preferably welded to the mounting plate, and sized to fit a hitch shank of a selected size. The receiver portion has an aperture through which the hitch shank may be pinned in order to secure it to the holder.

An accessory mounting bracket allows the first embodiment hitch holder to be removably installable on the horizontal surface. The flat mounting plate portion thereof, which need not be drilled for direct mounting, slides into the mounting bracket, to which it may be secured with a threaded fastener, such as a thumb screw.

A second embodiment of the hitch holder is designed for mounting on a vertical surface, such as the side panel of a frame rail. The advantage of such an arrangement is that the hitch holder need not be mounted in the bed where it is visible and may interfere with the carrying of cargo. Thus, the hitch holder and any hitches retained therein are hidden from view. The second embodiment hitch holder includes a flat mounting plate drilled to accept screw-type fasteners, by means of which the plate may be anchored to the vertical surface. As the frame rails constitute the major structural member of the vehicle, it is undesirable to drill holes in them or to weld objects to them. Welding may cause the welded region of the rail to become brittle and, thereby, cause it to crack under conditions of vibration. Most truck frames have hole patterns stamped at the factory. The mounting plate of the vertical-mount hitch holder may be drilled to match these existing hole patterns. The second embodiment hitch holder also includes a connector tube that is generally perpendicular to the major surfaces of the mounting plate. The connector tube is welded to both to the mounting plate and to a square-tube receiver portion. The square tube of the receiver portion is sized to fit a hitch shank of a chosen size. The square tube of the receiver portion has an aperture through which the hitch shank may be pinned in order to secure it to the holder.

A third embodiment hitch holder, which is designed for flush mounting on a horizontal body panel, includes a mounting plate portion having a generally square aperture. A receiver portion fits within the square aperture and is welded to the mounting plate portion. Because the receiver portion is below the surface of the body panel, it is generally not accessible. Thus, the receiver portion is equipped with a resiliently biased retaining mechanism so that when a hitch shank is inserted within the receiver portion, the retaining mechanism holds the hitch shank firmly in place.

For all embodiments of the hitch holder, a hitch holder tree having multiple receiver portions may be inserted within the receiver portion of any of the hitch holder embodiments. Each receiver portion of the hitch holder tree is designed to secure a hitch shank. Thus, the hitch tree permits multiple hitches to be held by a single hitch holder. Each receiver portion of the hitch holder tree may be of a different size so as to accommodate the carrying of hitches of various sizes.

### BRIEF DESCRIPTION OF THE DRAWINGS

FIG. 1 is a top plan view of a first embodiment hitch holder;

FIG. 2 is a side elevational view of the first embodiment hitch holder;

FIG. 3 is a front elevational view of the first embodiment hitch holder;

FIG. 4 is a side elevational view of the first embodiment hitch holder having a hitch shank inserted therein, the holder being installed on the body panel of a vehicle;

FIG. 5 is a top plan view of a mounting bracket used in combination with the second embodiment hitch holder;

FIG. 6 is a front elevational view of the mounting bracket of FIG. 5;

FIG. 7 is a front elevational view of a first embodiment hitch holder engaged with the mounting bracket of FIGS. 5 and 6, the latter being installed on the body panel of a vehicle;

FIG. 8 is a rear elevational view of the assembly of FIG. 7;

FIG. 9 is a front elevational view of a second embodiment hitch holder;

FIG. 10 is a top plan view of the second embodiment hitch holder;

FIG. 11 is a side elevational view of the second embodiment hitch holder;

FIG. 12 is a side elevational view of a third embodiment hitch holder;

FIG. 13 is a front elevational view of the third embodiment hitch holder;

FIG. 14 is a top plan view of the third embodiment hitch holder;

FIG. 15 is a front elevational view of the third embodiment hitch holder flush mounted through a vehicle body panel; and

FIG. 16 is a front elevational view of a hitch holder tree.

### PREFERRED EMBODIMENT OF THE INVENTION

Several embodiments of the new hitch holder will now be described with reference to the attached drawing figures. It should be understood that the drawings are not necessarily drawn to scale, and should be considered as only illustrative of the invention. All embodiments of the invention are preferably constructed from a structural metal such as mild steel or an alloy of aluminum.

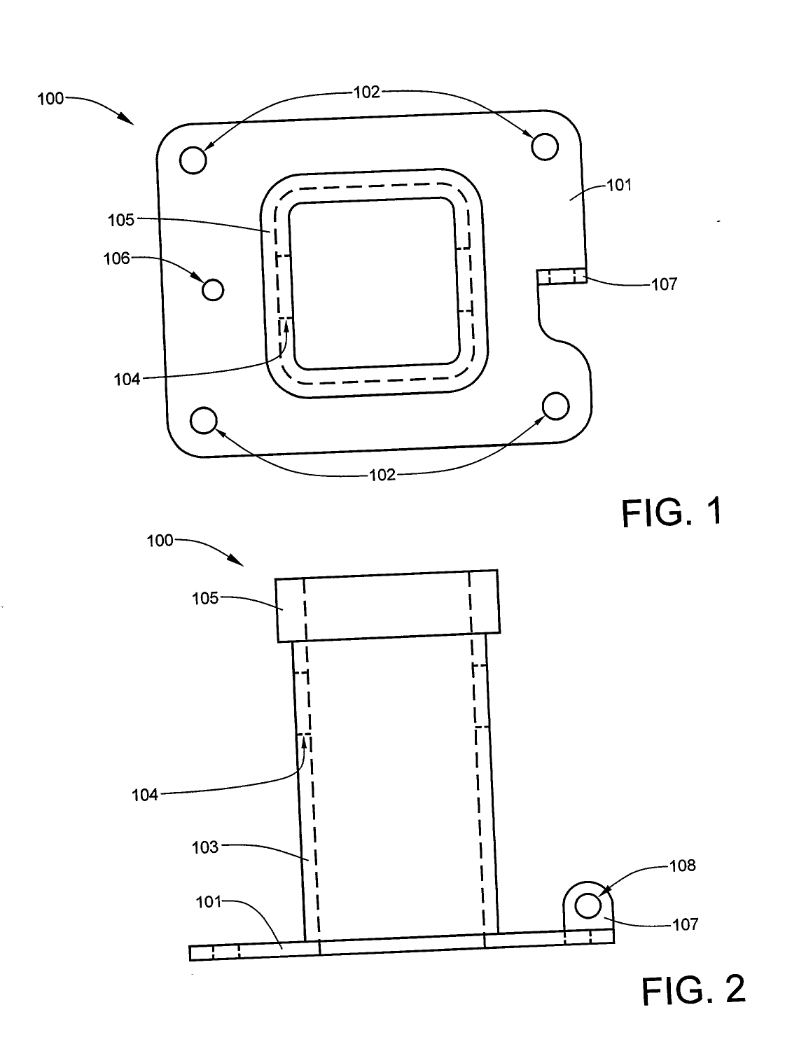

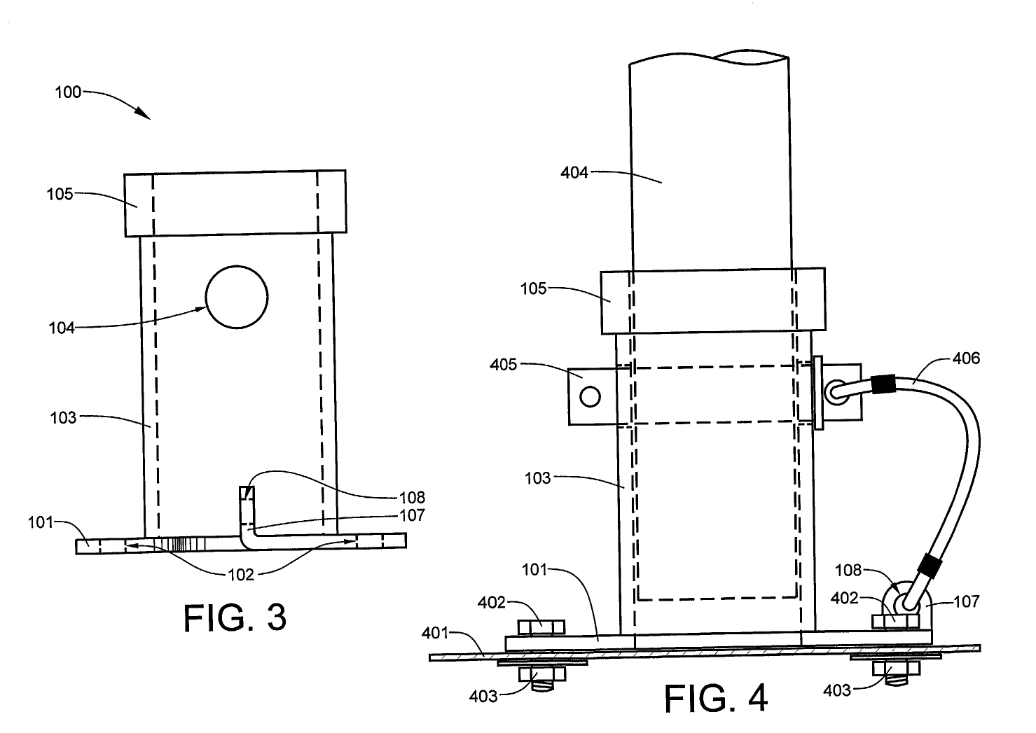

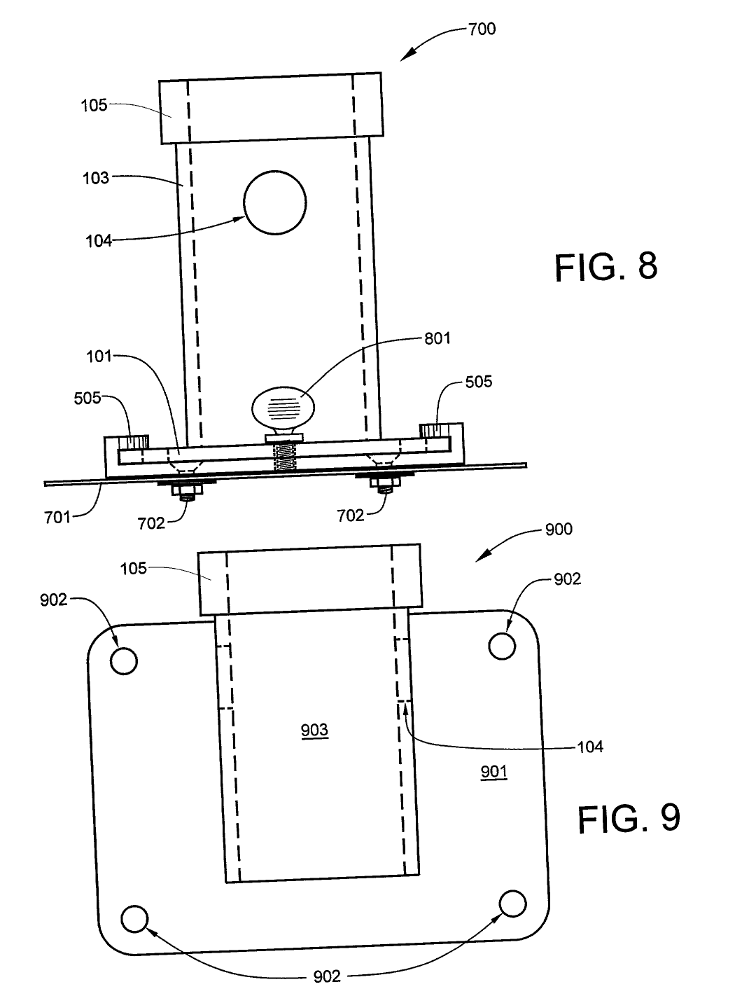

Referring now to FIGS. 1 through 3, a first embodiment hitch holder 100 is designed for mounting on a horizontal surface, such as the floor of a pick-up bed. This embodiment includes a flat mounting plate 101 provided with a plurality of mounting holes 102 for receiving screw-type fasteners, by means of which the plate 101 may be anchored to the horizontal surface. It also includes a square-tube receiver portion 103 that is preferably welded to the mounting plate 101, and sized to fit a hitch shank (not shown in this figure) of a selected size. The receiver portion has a securing aperture 104 through which the hitch shank may be pinned in order to secure it to the holder 100. The square-tube receiver portion 103 may be optionally equipped with a reinforcing collar 105. The mounting plate 101 may also have a secondary aperture 106, which as will be seen in FIG. 8, may be used to secure the first embodiment hitch holder 100 to a mounting bracket. A tab 107, formed by stamping and bending upward a portion of the mounting plate, has a securing aperture 108 therein.

Referring now to FIG. 4, a first embodiment hitch holder 100 is shown mounted on a vehicle body panel 401 having a horizontal surface 202, such as the bed of a pickup truck. Bolts 402 and nuts 403, which pass through the mounting holes 102 are used to secure the hitch holder to the body panel 401. The shank 404 of a hitch is shown inserted within the receiver portion 103 of the first embodiment hitch holder 100. A cylindrical pin 405, secured to the tab 106 with a flexible cable 406 is used to secure the shank 404 to the receiver portion 103. A cotter pin or spring clip (not shown) may be inserted through the hole 407 in the pin 405 in order to secure the latter within the securing aperture 104.

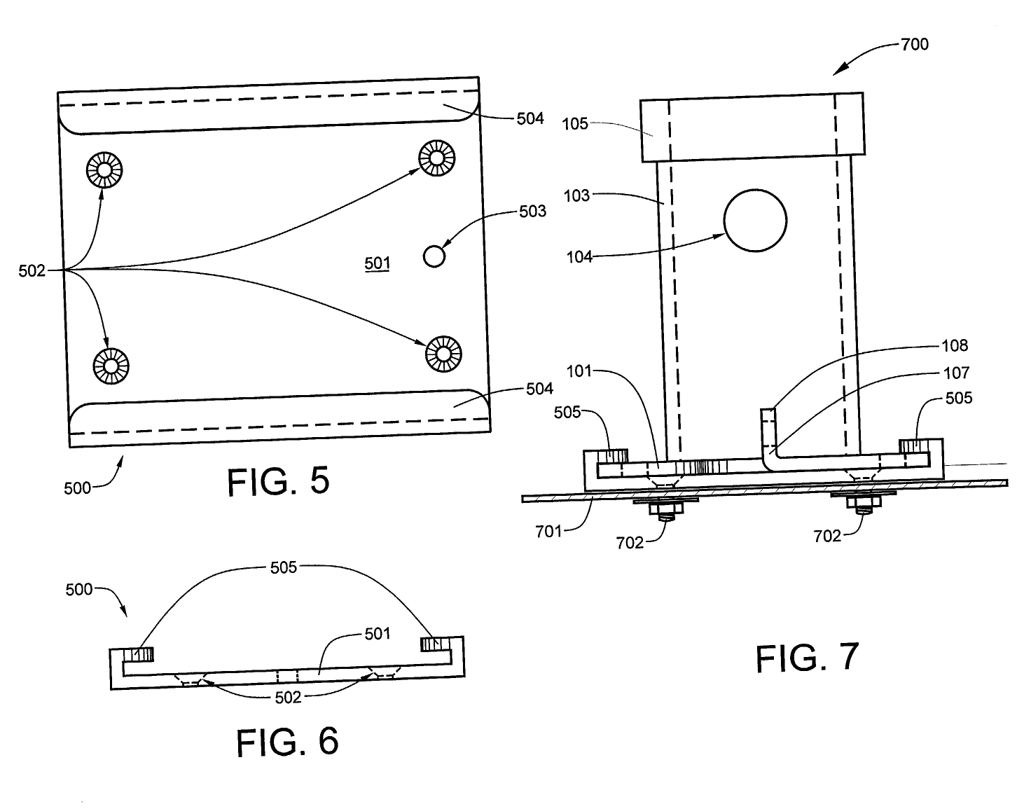

Referring now to FIGS. 5 and 6, a mounting bracket 500 is designed to receive the hitch holder 100 of FIGS. 1 through 4 to form an assembly. The holder 100 may be reversably secured to the mounting bracket 500. The mounting bracket 500 includes a base portion 501 and two opposed channel portions 502, each of which is continuous with the base portion 501. The base portion includes four countersunk mounting holes 503, by means of which the mounting bracket 500 may be secured to a vehicle body panel. A first coupling tab 504 having a first locking aperture 505 is welded to the base portion 501. Alternatively, the first coupling tab 504 may be formed in the same manner that tab 106 is formed, i.e., shearing and bending the base portion 501. FIGS. 7 and 8 show a first embodiment hitch holder 100 secured in the mounting bracket 500, thereby forming a removable hitch holder assembly 700. The hitch holder assembly 700 is mounted on a horizontal vehicle body panel 701 with screw-type fasteners 702.

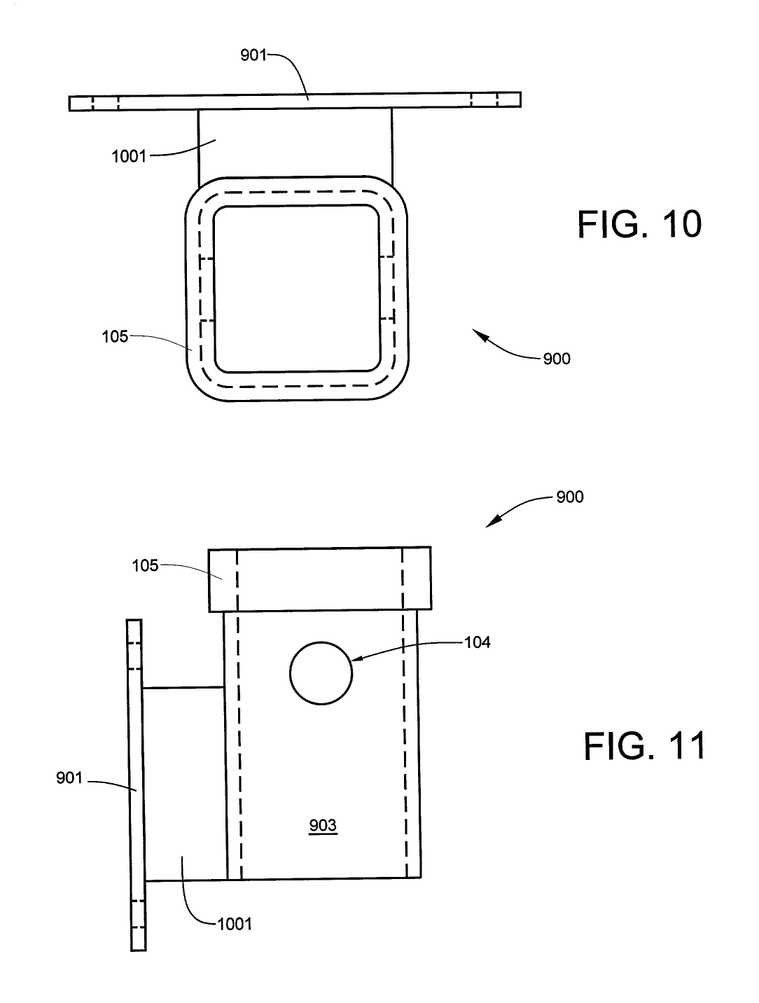

FIGS. 9, 10 and 11 show an second main embodiment 900 of the hitch holder 900. It is designed for mounting primarily on a vertical surface, such as the side panel of a frame rail. The advantage of such an arrangement is that the alternative embodiment hitch holder 900 need not be mounted in, for example, the bed of a pickup truck, where it is visible and may interfere with the carrying of cargo. Thus, the hitch holder 900 and any hitches retained therein are hidden from view. The second main embodiment hitch holder 900 includes a flat mounting plate 901 which is equipped with a plurality of mounting holes 902 sized to accept screw-type fasteners, by means of which the plate may be anchored to the vertical surface. As the frame rails constitute the major structural member of the vehicle, it is undesirable to drill holes in them or to weld objects to them. Drilling holes in a main frame member will weaken that member, while welding may cause the affected region of the rail to become brittle and, thereby, cause it to crack under conditions of vibration. Most truck frames have certain hole patterns stamped at the factory. The mounting plate 901 of the vertical-mount hitch holder 900 may be equipped with mounting holes to match these existing hole patterns. The second main embodiment hitch holder 900 also includes a connector tube 1001 that is generally perpendicular to the major surfaces of the mounting plate. The connector tube 1001 is welded to both to the mounting plate 901 and to a square-tube receiver portion 903. The square tube of a square-tube receiver portion 903 is sized to fit a hitch shank (not shown) of a chosen size. The receiver portion 903 has an aperture 104 through which a hitch shank may be pinned in order to secure it to the holder.

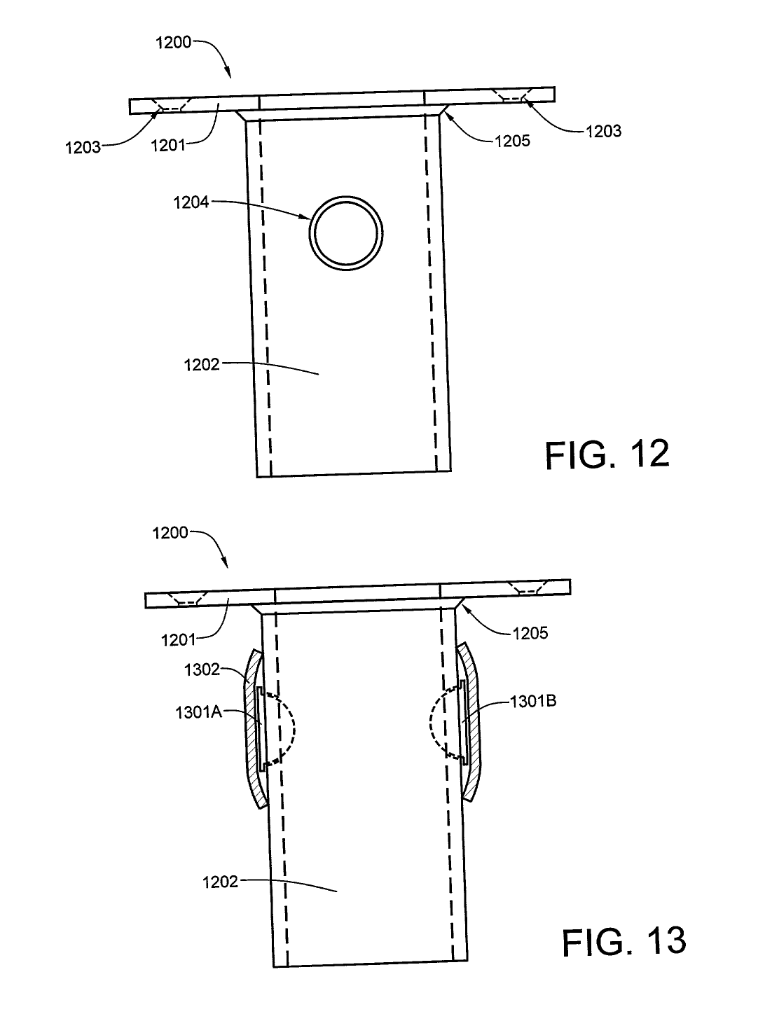

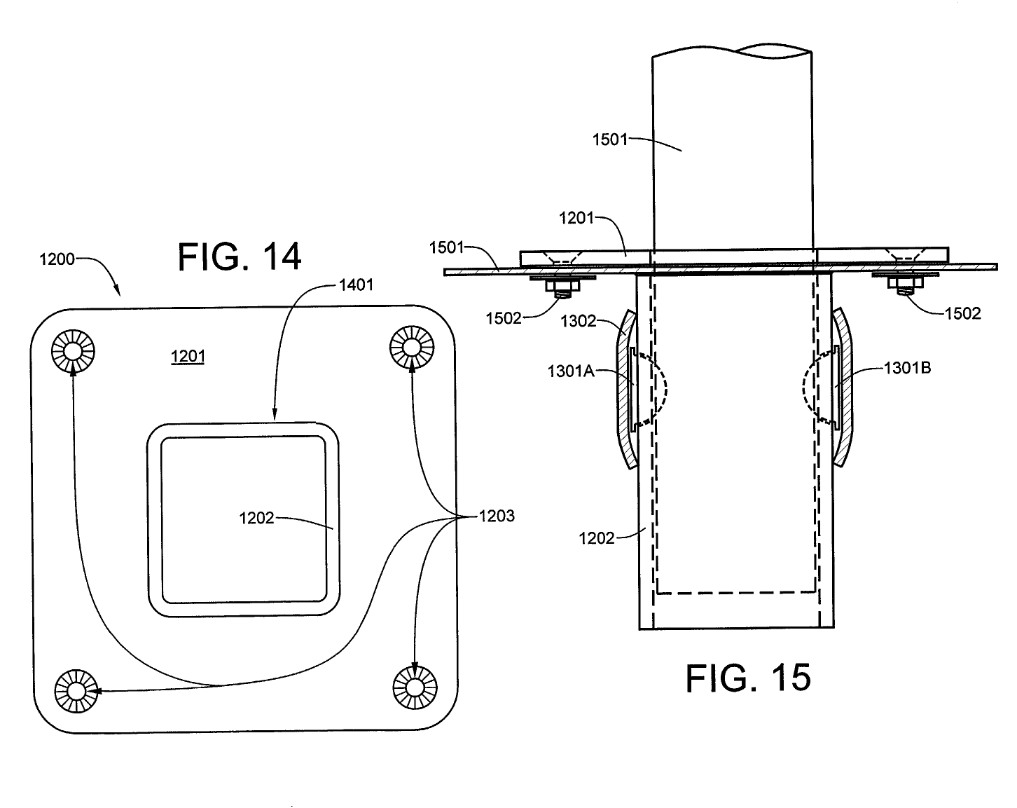

A third main embodiment hitch holder 1200, which is designed for flush mounting on a horizontal body panel, is shown in FIGS. 12 through 15. The third main embodiment holder 1200 includes a mounting plate portion 1201 having a generally square aperture 1202. A receiver portion 1203 fits within the square aperture 1202 and is welded to the mounting plate portion 1201. The welded union results is a weld bead 1204. Because the receiver portion 1203 is below the surface of the body panel, it is generally not accessible. The receiver portion 1203 is equipped with a pair of spherically ground apertures 1205A and 1205B.

Referring now to FIG. 13, a pair of hemispherical retainers 1301A and 1301B fit within the apertures 1205A and 1205B. The retainers 1301A and 1301B are held within the apertures 1205A and 1205B with a resilient strap 1302 (shown in cross section), that surrounds the receiver portion 1203.

Referring now to FIG. 15, when a hitch shank 1501 is inserted within the receiver portion 1203, the retainers 1301A and 1301B are forced away from their seated position in the spherically ground apertures 1205A and 1205B. When the aperture of the hitch shank 1501 is aligned with the apertures 1205A and 1205B, the retainers 1301A and 1301B snap back into place, thereby preventing the hitch shank from moving within or bouncing out of the receiver portion 1203.

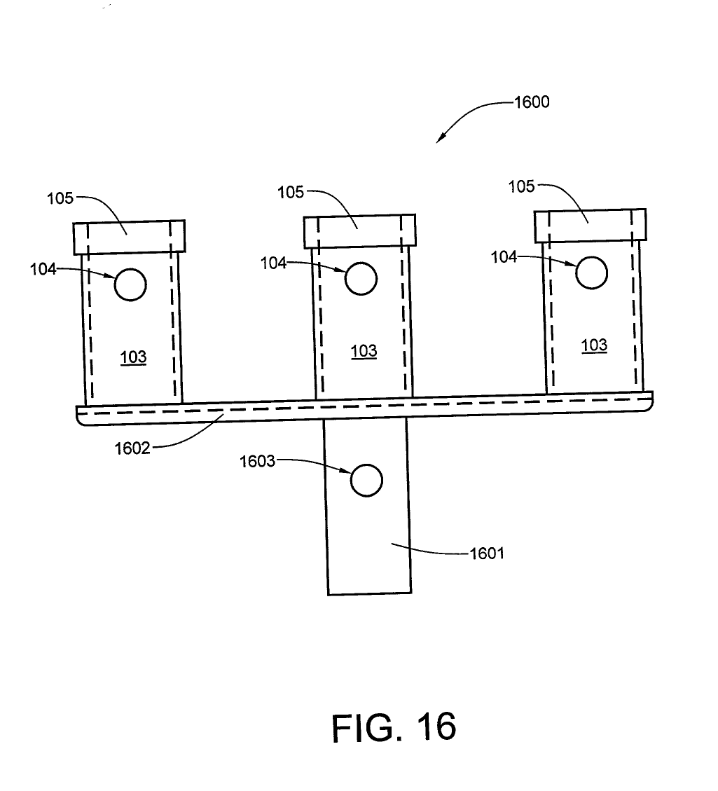

Referring now to FIG. 16, a hitch holder tree 1601 having multiple receiver portions 103A, 103B and 103C may be utilized in combination with any of the three hitch holders heretofore described (i.e., 100, 1000 and 1100). A square-tube attachment shank 1601 of the holder tree 1601 is insertable within the receiver portion 103 of any of the hitch holder embodiments. Each receiver portion 103A, 103B and 103C of the hitch holder tree is designed to secure a hitch shank. Thus, the hitch tree permits multiple hitches to be held by a single hitch holder. Each receiver portion of the hitch holder tree may be of a different size so as to accommodate the carrying of hitches of various sizes.

Although only several embodiments of the hitch holder have been heretofore described, it will be obvious to those having ordinary skill in the art that changes and modifications may be made thereto without departing from the scope and the spirit of the invention as hereinafter claimed.

What is claimed is:

1. A hitch holder comprising:
a receiver portion into which a hitch shank may be reversably inserted; and
means for mounting said receiver portion on a substantially planar surface of a vehicle.

2. The hitch holder of claim method of claim 1, wherein said receiver portion has an aperture through which a hitch shank may be secured with a hitch pin.

3. The hitch holder of claim 1, wherein said means for mounting comprises a mounting plate coupled to said receiver portion, said mounting plate attachable directly to the planar surface.

4. The hitch holder of claim 3, wherein said receiver portion is designed for flush mounting below the planar surface.

5. The hitch holder of claim 4, which further comprises at least one generally hemispherical retainer resiliently biased and seated within an aperture in the receiver portion, said aperture in the receiver portion aligning with an aperture in a hitch shank so that the hemispherical retainer is also seated within the aperture of the hitch shank so as to restrict movement of the latter.

6. The hitch holder of claim 3, wherein said receiver portion is coupled to said mounting plate via a connector tube, and said mounting plate is adapted for mounting on a generally vertical planar surface.

7. The hitch holder of claim 6, wherein said mounting plate includes a plurality of apertures which are sized and spaced to coincide with factory stamped apertures in a main frame member of a pickup truck.

8. The hitch holder of claim 1, wherein said means for mounting comprises:
a mounting bracket directly attachable to the planar surface;
a mounting plate coupled to said receiver portion, said mounting plate reversably engaging said mounting bracket.

9. The hitch holder of claim 8, wherein said planar surface is generally horizontal.

10. The hitch holder of claim 8, wherein said mounting bracket is formed as a slotted cage into which the mounting plate reversably slides.

11. The hitch holder of claim 1, which further comprises a hitch tree having a shank portion sized to engage said primary receiver portion and multiple secondary receiver portions, each of which is sized to receive the shank of a hitch.

12. The hitch holder of claim 11, wherein said shank portion and each secondary receiver portions includes an aperture for receiving a hitch pin.

13. A hitch holder comprising:
a primary receiver portion into which a hitch shank may be reversably inserted; and
a mounting plate coupled to said receiver portion, said mounting plate attachable to a substantially planar surface on a vehicle.

14. The hitch holder of claim method of claim 13, wherein said receiver portion has an aperture through which a hitch shank may be secured with a hitch pin.

15. The hitch holder of claim 13, wherein said mounting plate is coupled directly to said receiver portion and said mounting plate is equipped with at least one aperture, by means of which said mounting plate is attachable to a generally horizontal planar surface with at least one screw-type fastener.

16. The hitch holder of claim 13, which further comprises a mounting bracket directly attachable to the planar surface, and said mounting plate is slidably and reversably engageable with said mounting bracket.

17. The hitch holder of claim 13, wherein said mounting plate is coupled to said receiver portion via a connector tube, and said mounting plate having at least one aperture, by means of which said mounting plate is attachable to a generally vertical planar surface with at least one screw-type fastener.

18. The hitch holder of claim 17 wherein said mounting plate includes a plurality of apertures which are sized and spaced to coincide with factory stamped apertures in a main frame member of a pickup truck.

19. The hitch holder of claim 13, which further comprises a hitch tree having a shank portion sized to engage said primary receiver portion and multiple secondary receiver portions, each of which is sized to receive the shank of a hitch.

20. The hitch holder of claim 19, wherein said shank portion and each secondary receiver portions includes an aperture for receiving a hitch pin.
